(19) United States
(12) Patent Application Publication
(10) Pub. No.: US 2013/0000568 A1
(43) Pub. Date: Jan. 3, 2013

(54) FUEL CRACKING FOR INTERNAL COMBUSTION ENGINES

(75) Inventor: Robert B. Fowler, Jupiter, FL (US)

(73) Assignee: UNITED TECHNOLOGIES CORPORATION, Hartford, CT (US)

(21) Appl. No.: 13/173,544

(22) Filed: Jun. 30, 2011

(51) Int. Cl. F02B 43/00; F02B 43/12

(52) U.S. Cl. 123/3

(57) ABSTRACT

A fuel conditioning system includes a fuel supply, cracking vessel, heat source and fuel delivery line. The cracking vessel breaks carbon-carbon bonds of hydrocarbons present in the fuel. The heat source provides thermal energy to the cracking vessel for breaking the carbon-carbon bonds. The fuel delivery line delivers cracked fuel to an internal combustion engine. An internal combustion engine system includes an engine having a combustion chamber and fuel injection system, a fuel supply, a fuel conditioning system and a fuel delivery line. The fuel conditioning system includes a heat loop that receives thermal energy and a cracking vessel that breaks carbon-carbon bonds of fuel hydrocarbons using the thermal energy. The fuel delivery line delivers cracked fuel to the engine. A method for operating an internal combustion engine includes delivering fuel to a cracking vessel, thermally cracking the fuel, delivering cracked fuel to an engine and combusting the cracked fuel.

### BACKGROUND

In an internal combustion engine, combustion occurs after a mixture of fuel and air is compressed during the upward stroke of a piston in a cylinder. A spark ignites a flame front that travels through the mixture, raising the temperature and pressure, which drives the piston downward. At the top of the stroke, the fuel and air is compressed to a predetermined volume to provide optimal power and efficiency for the engine. The greater the compression, the more energy and power obtained from a given mass of fuel.

The flame front that travels through the fuel/air mixture does not always proceed uniformly and smoothly. In some situations, one or more pockets of the mixture explodes before the flame front reaches it, ceasing the optimal combustion process and generating a shockwave that increases pressure within the cylinder dramatically. This phenomenon is known as “knock” or “pinging”. Engine knock can lead to engine wear and destruction. To reduce engine knock, engine designers generally modify engine variables that include the compression ratio, the fuel octane rating and the ignition timing.

Reducing the compression ratio of an engine can reduce engine knock. The compression ratio is the ratio of the volume of a combustion chamber from its largest capacity to its smallest capacity. However, an engine's compression ratio is normally determined early in the design process based on efficiency goals and experience. Reducing the compression ratio generally decreases engine efficiency and fuel economy. Increasing the octane rating of the fuel used in the engine can reduce engine knock. Most fuel sold in the United States has an octane rating between 87 and 93. The potential for engine knock can be reduced by using a fuel with a higher octane rating. However, transitioning from a fuel having an octane rating of 89 or 93 to a fuel having a higher octane rating (e.g., 100 octane aviation gasoline) is expensive. Higher octane fuel is also not always readily available. Delaying the initiation of the spark used during combustion can also reduce engine knock. This delay, however, comes at the expense of the power obtained from the downward stroke.

The present invention provides an internal combustion engine with a high compression ratio that reduces knock potential without resorting to high octane fuels or delayed ignition.

### SUMMARY

A fuel conditioning system includes a fuel supply, a cracking vessel, a heat source and a fuel delivery line. The cracking vessel receives fuel from the fuel supply and breaks carbon-carbon bonds of hydrocarbons present in the fuel. The heat source provides thermal energy to the cracking vessel for breaking the carbon-carbon bonds of the fuel hydrocarbons. The fuel delivery line delivers cracked fuel to an internal combustion engine.

An internal combustion engine system includes an engine, a fuel supply, a fuel conditioning system and a fuel delivery line. The engine has a combustion chamber for combusting a fuel to extract work and a fuel injection system for delivering a mixture of fuel and air to the combustion chamber. The fuel conditioning system includes a heat loop that receives thermal energy and a cracking vessel that receives fuel from the fuel supply and breaks carbon-carbon bonds of fuel hydrocarbons using the thermal energy received by the heat loop. The fuel delivery line delivers cracked fuel to the engine.

A method for operating an internal combustion engine includes delivering a fuel to a cracking vessel, thermally cracking the fuel in the cracking vessel, delivering cracked fuel to an engine and combusting the cracked fuel.

### BRIEF DESCRIPTION OF THE DRAWINGS

FIG. 1 illustrates a simplified schematic of an internal combustion engine system.

FIG. 2 illustrates a simplified schematic of another internal combustion engine system.

FIG. 3 illustrates a method for operating an internal combustion engine.

### DETAILED DESCRIPTION

The present invention describes pre-combustion fuel cracking. Cracking fuel prior to combustion reduces the potential for engine knock and allows the engine to operate with an increased compression ratio. When cracked fuel is combusted within a combustion chamber, the flame front burns quickly and evenly within the combustion chamber, preventing pockets of the fuel/air mixture from detonating.

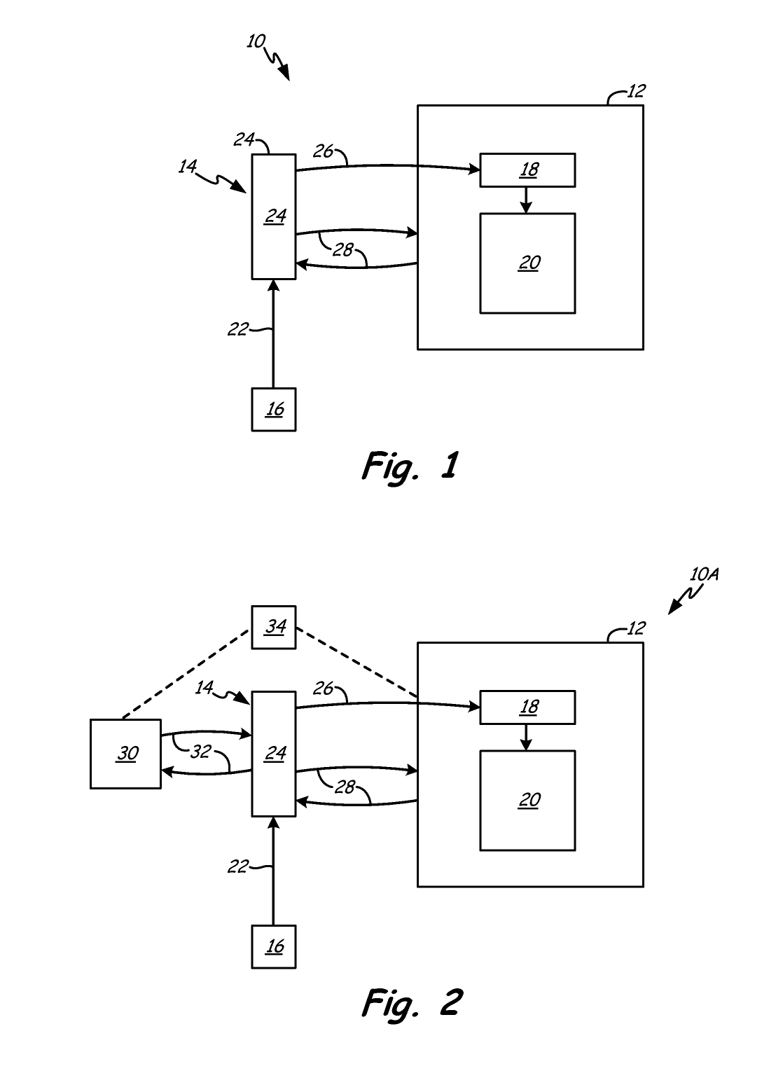

FIG. 1 illustrates a simplified schematic of an internal combustion engine system. Internal combustion engine system 10 includes engine 12, fuel conditioning system 14 and fuel supply 16. Engine 12 is any internal combustion engine including two-, four- and six-stroke reciprocating engines and rotary engines. Engine 12 includes fuel injection system 18 and combustion chamber 20. Fuel injection system 18 receives fuel and distributes the fuel to combustion chamber 20 to form the fuel/air mixture that is combusted within combustion chamber 20.

Fuel supply 16 delivers uncracked fuel, such as gasoline, to fuel conditioning system 14. The uncracked fuel typically contains hydrocarbon components having several carbon atoms. For example, most hydrocarbons present in gasoline contain between about four and twelve carbon atoms. Fuel conditioning system 14 conditions the uncracked fuel by cracking the fuel before it is combusted in combustion chamber 20. Fuel conditioning system 14 includes fuel inlet line 22, cracking vessel 24, fuel delivery line 26 and heat loop 28. Uncracked fuel from fuel supply 16 flows to cracking vessel 24 through fuel inlet line 22. The fuel is cracked in cracking vessel 24. The cracked fuel exits cracking vessel 24 and flows through fuel delivery line 26. Heat loop 28 communicates a heat exchange fluid between cracking vessel 24 and a heat source.

Inside cracking vessel 24, the fuel is exposed to thermal energy to facilitate cracking of the fuel. The heat source heats the heat exchange fluid. The heated fluid travels from the heat source to cracking vessel 24 through heat loop 28. In exemplary embodiments, the heat source produces a heated fluid at a temperature between about 370° C. (700° F.) and about 815° C. (1500° F.).

Thermal energy from the heat exchange fluid is transferred to cracking vessel 24, where thermal energy breaks carbon-carbon bonds of the fuel hydrocarbons, reducing the size of the fuel hydrocarbons and generating small hydrocarbons, such as methane and ethane. For example, the C₄ to C₁₂ fuel hydrocarbons present in untreated gasoline are cracked in cracking vessel 24 to produce fuel hydrocarbons having shorter carbon chains, increasing the overall volatility of the fuel and generating fuel hydrocarbons that will burn more smoothly within combustion chamber 20. In exemplary embodiments, the heat exchange fluid heats cracking vessel 24 and its contents to a temperature between about 260° C. (500° F.) and about 595° C. (1100° F.). As the temperature of cracking vessel 24 increases, the pressure within cracking vessel 24 also increases. The increased pressure within cracking vessel 24 also contributes to the breaking of fuel hydrocarbon carbon-carbon bonds. In exemplary embodiments, the pressure within cracking vessel 24 is between about 345 kPa (50 psi) and about 620 kPa (90 psi). In exemplary embodiments, cracking vessel 24 does not contain a catalyst used to catalytically crack fuel, but instead relies on thermal energy and the pressure within cracking vessel 24.

Cracked fuel exits cracking vessel 24 through fuel delivery line 26. Fuel delivery line 26 delivers the cracked fuel to fuel injection system 18, which then prepares the fuel/air mixture that is combusted within combustion chamber 20. Due to the elevated temperature of cracking vessel 24 and the elevated pressure within cracking vessel 24, the cracked fuel delivered through duel delivery line 26 has an elevated temperature and pressure. The elevated temperature and pressure of the cracked fuel provide benefits to internal combustion engine system 10. For example, the elevated temperature of the cracked fuel better prepares the fuel for combustion by increasing the fuel's vapor pressure. Increasing the fuel's vapor pressure reduces the likelihood of pockets of the fuel/air mixture forming and detonating prior to combustion. The elevated pressure of the cracked fuel also reduces the pumping power required to deliver the cracked fuel from fuel conditioning system 14 to fuel injection system 18. Additionally, the critical pressure of the cracked fuel is lower than that of standard (uncracked) fuel. The elevated pressure of the cracked fuel leaving cracking vessel 24 and the lowered critical pressure of the cracked fuel can reduce the pressure needed to deliver the cracked fuel to combustion chamber 20 by as much as 100 kPa (15 psi).

The cracked fuel is combusted within combustion chamber 20. At the time of combustion, the fuel hydrocarbons present in the cracked fuel have shorter chain lengths than the fuel delivered to cracking vessel 24 from fuel supply 16. The cracked fuel contains more short chain and volatile hydrocarbons, such as methane and ethane. For a fuel to burn properly, the fuel must vaporize and be broken down to short chain hydrocarbons. The increased concentration of short chain hydrocarbons allows the flame front generated during combustion to travel more quickly through combustion chamber 20, burning the cracked fuel before any pockets of the fuel/air mixture have a chance to prematurely detonate. The smaller the hydrocarbon chain lengths, the faster the flame front proceeds through the fuel/air mixture in combustion chamber 20. The flame front in cracked fuel proceeds more quickly than in uncracked fuel. The increased speed of the flame front in cracked fuel, allows engine 12 to have a higher compression ratio than a comparable engine burning uncracked fuel. Engine 12 having fuel conditioning system 14 can possess a compression ratio about 60% greater than other engines using the same source of fuel. In exemplary embodiments, engine 12 possesses a compression ratio between about 14 to 1 and about 18 to 1.

In the embodiment illustrated in FIG. 1, engine 12 serves as the heat source. Engine 12 generates heat during operation. Combusting fuel in combustion chamber 20 produces energy. Some of this energy is extracted by engine 12 to generate motion. However, a great deal of this energy is released as heat. In embodiments in which engine 12 serves as the heat source for heat loop 28, the heat given off by engine 12 during combustion is used to provide the thermal energy needed to crack the fuel in cracking vessel 24.

FIG. 2 illustrates a simplified schematic of another internal combustion engine system. Internal combustion engine system 10A contains the elements of internal combustion engine system 10 described above in addition to auxiliary heat source 30, second heat loop 32 and control system 34. The operation of internal combustion engine system 10 is described with respect to fuel conditioning during steady-state engine operation (after engine 12 has started up and has begun combusting fuel). When engine 12 first begins operating and combusting fuel, engine 12 cannot provide the thermal energy required to raise the temperature of cracking vessel 24 so that fuel cracking can occur. Until engine 12 is producing enough heat to provide sufficiently heated heat exchange fluid through heat loop 28, cracking vessel 24 requires thermal energy from a separate heat source. Auxiliary heat source 30 heats a second heat exchange fluid that is delivered to cracking vessel 24 through second heat loop 32. Auxiliary heat source 30 provides thermal energy to cracking vessel 24 necessary for cracking the fuel until engine 12 has reached steady-state operation. Control system 34 determines and controls which heat source (12 or 30) communicates heat exchange fluid with cracking vessel 24. Control system 34 receives input from temperature and/or pressure sensors in engine 12. When engine 12 is not operating at a steady-state condition, control system 34 allows auxiliary heat source 30 to provide cracking vessel 24 with thermal energy via second heat loop 32. When engine 12 is operating at a steady-state condition, control system 34 allows engine 12 to provide cracking vessel 24 with thermal energy via heat loop 28 and shuts down auxiliary heat source 30 to conserve energy. Control system 34 can also allow the simultaneous transfer of thermal energy from both engine 12 and auxiliary heat source 30 to cracking vessel 24.

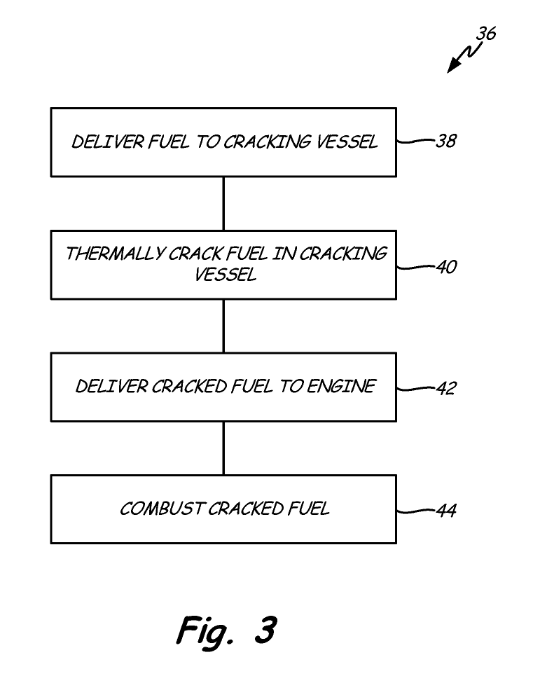

FIG. 3 illustrates a method for operating internal combustion engine systems 10 and 10A described above. Method 36 includes delivering a fuel to a cracking vessel (step 38), thermally cracking the fuel in the cracking vessel (step 40), delivering cracked fuel to an engine (step 42) and combusting the cracked fuel (step 44). In step 38, uncracked fuel is delivered from fuel supply 16 to cracking vessel 24. In step 40, thermal energy is used to crack the fuel in cracking vessel 24. The thermal energy used to crack the fuel is provided by a heat source, such as engine 12 or auxiliary heat source 30. In one embodiment, a heat exchange fluid is recirculated between the engine and the cracking vessel. The engine heats the fluid using the heat given off by fuel combustion within the engine. Once heated, the fluid is delivered to cracking vessel 24 to provide thermal energy. The fluid is then returned to engine 12 so that it can be heated again and the process repeated. Cracking the fuel reduces the carbon chain lengths of hydrocarbons present in the fuel, producing short chain hydrocarbons methane and ethane and increasing vaporization of the fuel. In exemplary embodiments, the fuel is cracked at a temperature between about 260° C. (500° F.) and about 595° C. (1100° F.) and at a pressure between about 345 kPa (50 psi) and about 620 kPa (90 psi) without the use of catalysts.

In step 42, the cracked fuel is delivered to engine 12. In exemplary embodiments, the cracked fuel is delivered to an injection system in engine 12 at a pressure between about 275 kPa (40 psi) and about 550 kPa (80 psi), reducing the power requirement for any fuel pumps or eliminating their need altogether. The cracked fuel is mixed with air to form a fuel/air mixture. In step 42, the fuel/air mixture is combusted to produce work. Method 36 is performed within a single internal combustion engine system (i.e. the fuel is not cracked at a site separate from the engine and then added to an engine fuel supply). The steps of method 36 are performed in a short time span, nearly simultaneously. Method 36 provides for internal combustion engine operation that allows for an increased compression ratio without subjecting engine operation to increased engine knock.

By cracking fuel in a cracking vessel just prior to fuel combustion, proper combustion of the fuel is encouraged. Reducing the carbon chain lengths of fuel hydrocarbons increases the speed of the flame front during combustion, reducing the potential for engine knock. The increased flame speed allows the internal combustion to operate with an increased compression ratio without increasing the potential for engine knock.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fuel conditioning system comprising:
a fuel supply for providing a fuel;
a cracking vessel for receiving the fuel from the fuel supply and breaking carbon-carbon bonds of hydrocarbons present in the fuel;
a heat source for providing thermal energy to the cracking vessel for breaking carbon-carbon bonds of the fuel hydrocarbons to produce cracked fuel; and
a fuel delivery line for delivering the cracked fuel to an internal combustion engine.

2. The fuel conditioning system of claim 1, wherein the heat source is the internal combustion engine receiving the cracked fuel.

3. The fuel conditioning system of claim 2, further comprising:
an additional heat source, wherein the additional heat source provides thermal energy to the cracking vessel until the internal combustion engine alone provides sufficient thermal energy to break the carbon-carbon bonds of the fuel hydrocarbons.

4. The fuel conditioning system of claim 3, further comprising:
a control system for controlling the amount of thermal energy the cracking vessel receives from the heat source and the additional heat source.

5. The fuel conditioning system of claim 1, wherein no catalyst is present in the cracking vessel.

6. The fuel conditioning system of claim 1, wherein the heat source produces a heating fluid at a temperature between about 370° C. (700° F.) and about 815° C. (1500° F.).

7. The fuel conditioning system of claim 1, wherein the fuel delivery line is connected to a fuel injection system of the internal combustion engine and delivers fuel to the fuel injection system at a pressure between about 275 kPa (40 psi) and about 550 kPa (80 psi).

8. An internal combustion engine system comprising:
an engine comprising:
a combustion chamber for combusting a fuel to extract work;
a fuel injection system for delivering a mixture of fuel and air to the combustion chamber; and
a fuel supply;
a fuel conditioning system comprising:
a heat loop for receiving thermal energy;
a cracking vessel for receiving fuel from the fuel supply and breaking carbon-carbon bonds of fuel hydrocarbons using the thermal energy received by the heat loop to produce cracked fuel;
a fuel delivery line for delivering the cracked fuel to the engine.

9. The internal combustion engine system of claim 8, wherein the heat loop receives thermal energy from the engine.

10. The internal combustion engine system of claim 9, wherein the heat loop receives thermal energy from an additional heat source, wherein the additional heat source provides thermal energy until the engine alone provides sufficient thermal energy to break the carbon-carbon bonds of the fuel hydrocarbons.

11. The internal combustion engine system of claim 10, further comprising:
a control system for controlling the amount of thermal energy the heat loop receives from the engine and the additional heat source.

12. The internal combustion engine system of claim 8, wherein no catalyst is present in the cracking vessel.

13. The fuel conditioning system of claim 1, wherein the fuel delivery line delivers fuel to the fuel injection system at a pressure between about 275 kPa (40 psi) and about 550 kPa (80 psi).

14. The fuel conditioning system of claim 1, wherein the engine has a compression ratio between about 14 to 1 and about 18 to 1.

15. A method for operating an internal combustion engine, the method comprising:
delivering a fuel to a cracking vessel;
thermally cracking the fuel in the cracking vessel to produce cracked fuel;
delivering the cracked fuel to the internal combustion engine; and
combusting the cracked fuel in the internal combustion engine.

16. The method of claim 15, wherein heat used to thermally crack the fuel in the cracking vessel is supplied by a heating fluid generated by combusting cracked fuel in the internal combustion engine.

17. The method of claim 16, wherein the heating fluid is recirculated between the internal combustion engine and the cracking vessel.

18. The method of claim 15, wherein the fuel is cracked at a temperature between about 260° C. (500° F.) and about 595° C. (1100° F.) and at a pressure between about 345 kPa (50 psi) and about 620 kPa (90 psi).

19. The method of claim 15, wherein catalysts are not used to crack the fuel in the cracking vessel.

20. The method of claim 15, wherein the cracked fuel is delivered to an injection system of the internal combustion engine at a pressure between about 275 kPa (40 psi) and about 550 kPa (80 psi).

21. The method of claim 15, wherein thermally cracking the fuel produces methane and ethane and increases vaporization of the fuel.
